(19) United States
(12) Patent Application Publication
(10) Pub. No.: US 2017/0069917 A1
(43) Pub. Date: Mar. 9, 2017

(54) GROWING METHOD OF LAYERS FOR PROTECTING METAL INTERCONNECTS OF SOLID OXIDE FUEL CELLS

(71) Applicant: Institute of Nuclear Energy Research, Atomic Energy Council, Executive Yuan, TAOYUAN COUNTY (TW)

(72) Inventors: CHANG-SING HWANG, TAOYUAN COUNTY (TW); CHUN-LIANG CHANG, TAOYUAN COUNTY (TW); CHUN-HUANG TSAI, TAOYUAN COUNTY (TW); ZONG-YANG CHUANG SHIE, TAOYUAN COUNTY (TW); SHENG-FU YANG, TAOYUAN COUNTY (TW); TE-JUNG HUANG, TAOYUAN COUNTY (TW)

(21) Appl. No.: 14/847,119

(22) Filed: Sep. 8, 2015

(51) Int. Cl. H01M 8/02; C23C 4/12; C23C 4/02; H01M 8/12

(52) U.S. Cl. CPC H01M 8/0228; H01M 8/1246; C23C 4/127; C23C 4/02; H01M 2008/1293

(57) ABSTRACT

A growing method of layers for protecting metal interconnects of solid oxide fuel cells includes the steps of: processing a pre-heating or a pre-oxidation and pre-heating procedure upon a metal interconnect, providing several granulated powder groups with individual particle size distributions, selecting one of the granulated powder groups, sending granulated powders of the selected powder group into a high speed high temperature plasma flame, melting the selected granulated powders by the high speed high temperature plasma flame, impacting the metal interconnect by the melted powders with high speeds, and forming a protective layer and a middle layer on the metal interconnect, in which the middle layer is sandwiched between the protective layer and the metal interconnect. The combination of the protective layer, the middle layer and the spinel layer provides a way to reduce the surface ohmic resistance of the metal interconnect and the extent of Cr induced cathode poisoning

### BACKGROUND OF INVENTION

1. Field of the Invention

The invention relates to a growing method of layers for protecting metal interconnects of solid oxide fuel cells (SOFCs), and more particularly to the growing method of layers that can slow down the increase of the contact ohmic resistance on the metal interconnect's surface and reduce the Cr (Chromium) induced cathode poisoning, such that the service life of the solid oxide fuel cells system can be prolonged.

2. Description of the Prior Art

In the stack structure of the solid oxide fuel cells, several solid oxide fuel cells and several metal interconnects are included.

The metal interconnects are usually positioned in a place at a high temperature ranging from 600 to 800° C. and a particular environment. This particular environment is that one side of interconnect is filled with air (or oxygen) and the other side of interconnect is filled with hydrogen and water vapor. In this kind of environment, therefore, the materials for the metal interconnects shall be able to have a capability to resist both corrosion and oxidation in a high temperature environment. Also, the expansion coefficients of qualified interconnect materials shall be compatible with the electrolytes of solid oxide fuel cells. Further, the metal interconnects shall have excellent electric conductivities, i.e. low resistance loss. In the recent art, the materials for metal interconnects are ferritic stainless steels containing Cr, such as Crofer 22 (ThyssenKrupp VDM), ZMG232 (Hitachi Metals) or SS441.

The stack of solid oxide fuel cells is usually operated at a temperature ranging from 600 to 800° C., under these high temperature environments, the metal interconnects that contain Cr and have a capability to resist both corrosion and oxidation in a high temperature environment will have Cr₂O₃ oxidation layers formed on the their surfaces. Though the Cr₂O₃ layer is electric conductive, this Cr₂O₃ layer cannot perform well in electric conduction under the high temperature operation environment of the solid oxide fuel cells, because the conductivity of Cr₂O₃ layer at 800° C. is only 1.5 S/cm, but the conductivities of lanthanum strontium manganite (LSM) oxide with a perovskite structure and Crofer 22 at 800° C. are 65 S/cm and 8700 S/cm, respectively.

The existence of the Cr₂O₃ layer increases the surface or contact ohmic resistance of the metal interconnect and leads to the increase in the accumulative ohmic resistance of the stack of solid oxide fuel cells. This increase in the ohmic resistance will increase the loss of electric energy and also reduce the power performances of the solid oxide fuel cells and stacks.

As the service time of the stack of solid oxide fuel cells increases, the Cr₂O₃ layers on the surfaces of the metal interconnects become thicker and thicker. Hence, the accumulative ohmic resistance of the stack of solid oxide fuel cells increases with time, this increase in ohmic resistance is one of main causes for the degradation of stack performance.

Further, at the air side of metal interconnect, i.e. the side facing a cathode, if the water vapor is added, a gas-phase Cr-contained material, such as CrO₂(OH)₂, would be generated through the interaction between the water vapor and the Cr₂O₃ layer of metal interconnect. This CrO₂(OH)₂ material can enter into the porous cathode, and finally converts to the solid Cr₂O₃ material that is deposited inside the cathode, thus the triple phase boundaries inside the cathode are greatly reduced. Consequently, the cathode efficiency on transforming oxygen gas molecules (O₂) into oxygen ion (O⁻) are greatly decreased too, this indicates Cr poisoning on cathode is a significant problem on the degradation of solid oxide fuel cells.

The gas-phase Cr-contained material like CrO₂(OH)₂ may also react with Mn (manganese) in the cathode to form an Mn—Cr spinel so as further to change the material properties and performance of the cathode. In addition, the gas-phase Cr-contained material like CrO₂(OH)₂ can also react with the Sr (strontium) in the cathode so as to form a SrCrO₄ insulator material which will increase the cathode resistance. Additionally, the Cr ion can diffuse out of the metal interconnect by solid state diffusion and enters into the cathode of solid oxide fuel cell to produce the Cr induced cathode poisoning

Currently, to reduce the surface ohmic resistance or an area specific resistance (ASR) of the metal interconnect and to minimize the extent of the cathode poisoning induced by the Cr-contained metal interconnects of the solid oxide fuel cells, a coated perovskite layer or spinel layer or combination of perovskite and spinel layers on the metal interconnect is mainly adopted to protect the metal interconnect.

The method for forming the aforesaid protective layers may be one of radio frequency (RF) reactive magnetron sputtering, electrophoresis, plasma spraying, sol-gel and ion beam sputtering methods. The RF reactive magnetron sputtering needs a vacuum device, and thus the cost for producing the aforesaid protective layer by this sputtering method is high. By applying any of the RF reactive magnetron sputtering and ion beam sputtering methods, the protective layer has a risk of containing some portion of amorphous phase which shall be further heat treated at high temperatures to achieve a complete crystallization. However, during the heat treatment process at high temperatures, the volume change from amorphous phase to crystal phase can induce cracks in the protective layer.

The methods of radio frequency (RF) reactive magnetron sputtering, electrophoresis, sol-gel and ion beam sputtering need a high temperature heat treatment process to get a completely crystallized protective layer. Additionally, the protective layer produced by the method of electrophoresis or sol-gel usually has a poor adhesion on the metal interconnect, compared to the protective layer produced by plasma spraying method. The plasma spraying method can form a completely crystallized protective layer directly onto the surface of the metal interconnect without the post high temperature heat treatment process and the expensive vacuum device, but the protective layer produced by current plasma spraying method usually contains a plurality of pores and cracks mixed with impurity phases, hence, this kind of protective layer need to be promoted to meet the application requirement for the solid oxide fuel cells.

A published paper by Pen Yang, et al, “Effects of pre-oxidation on the microstructural and electrical properties of La_{0.67}Sr_{0.33}MnO_{3-δ} coated ferritic stainless steels,” Journal of Power Sources, 213, 63, 2012 and a Taiwan patent 1329378 are both to disclose a method of radio frequency (RF) reactive magnetron sputtering for producing protective perovskite layers on metal interconnects. However, in these two documents, the protective perovskite layers of La_{0.67}Sr_{0.33}MnO_{3-δ} have many through-cracks due to the recrystallization of amorphous phases in their perovskite layers under the operation temperatures of solid oxide fuel cells. The scanning electron microscope (SEM) observations conducted by Pen Yang et al. also show that many Mn—Cr spinel crystals grow up and appear around the tops of cracks in their perovskite layers after 500 hours under the operation temperatures of solid oxide fuel cells. These Mn—Cr spinel crystals indicate that Cr can diffuse out of the metal interconnect and pass through their protective layers via the cracks in their protective layers easily and therefore the Cr induced cathode poisoning is inevitable. Similarly, if the other methods mentioned above produce the protective layers with many cracks including through-cracks so that the Cr that diffuses out of the metal interconnects can pass through the protective layers, then these protective layers are useless to solve the problem of Cr induced cathode poisoning

Further, in the case that the Mn—Cr spinel crystals that grow up and appear around the tops of through-cracks or on the surface of protective layer have higher resistances than the protective layer, then the ohmic contact resistances between cells and metal interconnects of the cell's stack increase.

In US Patent Publication No. US20130230792 and the journal paper “Improved oxidation resistance of ferritic steels with LSM coating for high temperature electrochemical applications”, International Journal of Hydrogen Energy, 37, 8087, 2012, published by Marian Palcut et. al., a method for producing a protective layer by plasma spraying is provided. According to these two disclosures, their observations by using scanning electron microscopes show that their protective layers are porous and have many cracks in their protective layers. Also, many almost vertical cracks have been found in their protective layers coated on the metal interconnects. Obviously, the functions provided by their protective layers to minimize the oxygen oxidation of metal interconnects and the Cr induced cathode poisoning are weak and far from satisfying the design demand.

Nevertheless, no matter what kind of the method is applied to produce the protective layers on the metal interconnects, the properties of high electron conductivity, low oxygen-ion conductivity and dense structure without through-cracks are required. As a dense protective layer without through-cracks is coated on the surface of the metal interconnect, this protective layer can then avoid or minimize the leakages of Cr or Cr and Mn from the metal interconnect, and in addition favors the formation of a spinel layer containing mainly Cr, Mn and O at the position between the protective layer and the metal interconnect, so that this spinel layer can further reduce oxygen diffusion into the metal interconnect and Cr or Cr and Mn diffusion out of the metal interconnect. On the contrary, if the protective layer is not dense enough and has through-cracks, then Cr and Mn of the metal interconnect can easily diffuse out of the metal interconnect, pass through the protective layer and favor the growth of Mn—Cr spinel crystals at the positions around the tops of through-cracks or on the surface of protective layer, this situation is unfavorable to the formation of Mn—Cr spinel at the position between the protective layer and the metal interconnect, in addition the leakage of Cr can further induce cathode poisoning

In the current art described above, no matter what kind of the method is applied, it is simply to coat a protective layer or layers, such as the perovskite LSM layer or the spinel layer (for instance, Mn-Co spinel layer) or the combination of perovskite LSM layer or the spinel layer, on the metal interconnect to reduce the possible leakage of Cr or/and Mn from the metal interconnect at first, and then by using the element diffusion and interaction between the protective layer (or layers) and the metal interconnect during the long term operation of solid oxide fuel cell, an additional dense spinel layer, for instance Mn—Cr spinel layer, is gradually generated between the protective layer (or layers) and the metal interconnect to further minimize the possible leakage of Cr or/and Mn from the metal interconnect. If the protective layer is not dense and has through-cracks, a leakage of Cr or Cr and Mn through the protective layer occurs, this leakage of Cr or Cr and Mn is unfavorable to form this additional dense spinel layer, in other words, it is needed to take more time to form his additional dense spinel layer, and finally results in a serious problem of Cr induced cathode poisoning

### SUMMARY OF THE INVENTION

Accordingly, it is the primary object of the present invention to provide a growing method of layers in the atmosphere environment for protecting metal interconnects of solid oxide fuel cells, a dense protective layer as well as a dense middle layer can be formed over the surface of the metal interconnect. The dense middle layer is formed by the effects of pre-heating of metal interconnect and high temperature coating of the protective layer. By providing initially the dense protective and middle layers, these two layers assist the contact portion between the middle layer and the metal interconnect to transform into a dense, well-conductive and continuous spinel layer containing mainly Cr, Mn and O on the surface of the metal interconnect under the operations of the solid oxide fuel cells via the element diffusion and interaction between the middle layer and the metal interconnect.

In the present invention, the dense protective layer and the dense middle layer are free of connected cavities or connected cracks or through-cracks that penetrate these dense protective and the middle layers. Hence, they can be integrated to work against the leakage of Cr or/and Mn from the metal interconnect more effectively. The combination of these two layers are more favorable to reduce the leakage of Cr or/and Mn from the metal interconnect and to form the aforesaid dense, well-conductive, and continuous spinel layer containing mainly Cr, Mn and O over the metal interconnect. This spinel layer can further provide the resistance against the leakage of Cr or Cr and Mn from the metal interconnects.

Accordingly, in the present invention, the growing method of layers for protecting metal interconnects of solid oxide fuel cells comprises the steps of:

performing a pre-heating process or a pre-oxidation and pre-heating process upon a metal interconnect in the atmosphere environment;

providing granulated powder groups by granulating powders and sieving granulated powders, selecting one of the granulated powder groups and sending granulated powders of the selected granulated powder group into a high speed and high temperature plasma flame, wherein each of the granulated powder groups has a specific particle size distribution; and

the high speed and high temperature plasma flame heating and melting the granulated powders of the selected granulated powder group, the melted and accelerated granulated powders impacting a surface of the metal interconnect with a high speed so as to form a protective layer and a middle layer simultaneously on the surface of the metal interconnect, wherein the middle layer is located between the protective layer and the metal interconnect.

In the present invention, the method is to form the protective layer and the middle layer simultaneously over the surface of the metal interconnect in the atmosphere environment, in which the middle layer is sandwiched between the protective layer and the metal interconnect. By providing the double protection given from the protective layer and the middle layer coated on the metal interconnect that works in a high temperature environment of solid oxide fuel cell, the oxygen diffusion into the metal interconnect to increase the thickness of Cr₂O₃ is minimized, and the ASR as well as the rate of change in the ASR at the atmosphere side of the metal interconnect can be significantly reduced. Hence, the surface ohmic resistance of the metal interconnect at the air side can satisfy the requirement of the ASR for solid oxide fuel cells. Further, based on the protection provided by the aforesaid protective layer, the aforesaid middle layer and the aforesaid spinel layer, the Cr leakage from the metal interconnect and the Cr induced cathode poisoning can be further minimized and finally the service life of the solid oxide fuel cells as well as the generation system thereof can be further extended.

All these objects achieved by the growing method of layers for protecting metal interconnects of solid oxide fuel cells are described below.

### BRIEF DESCRIPTION OF THE DRAWINGS

The present invention will now be specified with reference to its preferred embodiment illustrated in the drawings, in which:

FIG. 1 is a flowchart of the preferred growing method of layers for metal interconnects of solid oxide fuel cells in accordance with the present invention;

FIG. 2 gives schematically a view of a high speed and high temperature plasma flame working on a metal interconnect so as to form a protective layer and a middle layer simultaneously over the metal interconnect, in accordance with the present invention;

FIG. 3 is a cross-sectional SEM view of a protective layer and a middle layer prepared by the method of the present invention on a piece of pre-heated metal interconnect without any post-heat treatment in the atmosphere environment;

FIG. 4 gives signals obtained from energy-dispersive X-ray spectroscopy (EDX) at the point A shown in FIG. 3;

FIG. 5 gives line-scanning EDX signals of Fe and Cr across the middle layer of FIG. 3;

FIG. 6 is a cross-sectional SEM view of the protective layer and the middle layer prepared by the method of the present invention on a piece of pre-heated metal interconnect with a post-heat treatment at 800° C. for 600 hours in the atmosphere environment;

FIG. 7 gives EDX signals at the point B shown in FIG. 6;

FIG. 8 gives EDX signals at the point C shown in FIG. 6;

FIG. 9 gives two X-ray diffraction graphs of the protective layer before the post-heat treatment and after the post-heat treatment at 800° C. for 600 hours in the atmosphere environment;

FIG. 10 shows the long-term ASR measurement results for metal interconnects with LSM protective layers and without pre-oxidation treatment; and

FIG. 11 shows the long-term ASR measurement results for metal interconnects with LSM protective layers and pre-oxidation treatment.

### DESCRIPTION OF THE PREFERRED EMBODIMENT

The invention disclosed herein is directed to a growing method of layers for metal interconnects of solid oxide fuel cells. In the following description, numerous details are set forth in order to provide a thorough understanding of the present invention.

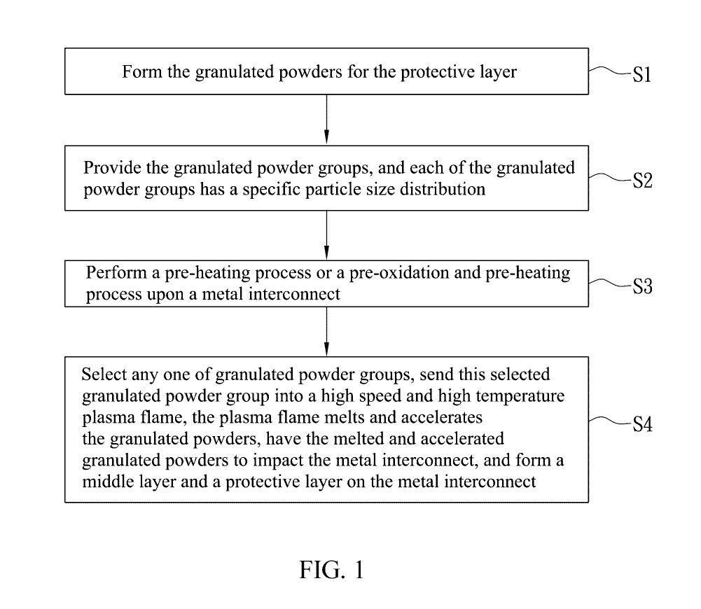

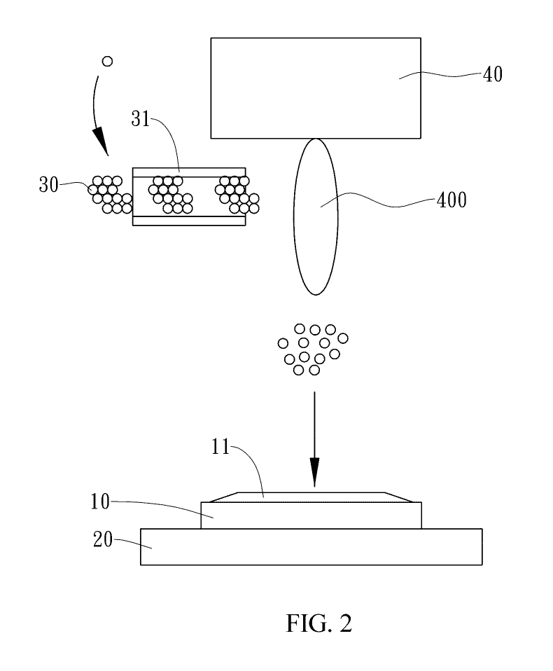

Referring now to FIG. 1 and FIG. 2, the growing method of layers for protecting metal interconnects of solid oxide fuel cells in accordance with the present invention comprises the following steps.

S1: Form granulated powders for the protective layer.

The original powders to be granulated for the protective layer have powder sizes of nano or submicron or micron, or powder sizes no more than 10 μm and are made of a material with poor oxygen-ion conductivity but excellent electron conductivity, such as a LSM (La₁₋ₓSrₓMnO_{3-δ}, x=0.2˜0.4) oxide with a perovskite structure or a material of spinel. The spinel can be Mn—Co (manganese-cobalt) spinel or Mn—Co—Fe (manganese-cobalt-iron) spinel, or Mn—Co—Cu (manganese-cobalt-copper) spinel.

The granulation process is provided, but not limited to, as follows:

As mentioned above, the original powders to be granulated for producing the protective layer can be nano or submicron or micron powders, or powders with sizes no more than 10 μm, in which the shapes of the original powders are not specifically specified. After the granulation process, in order to obtain better flow-ability of the granulated powders, the shape of the granulated powders is near a ball shape and the sizes of the granulated powders range from 10 to 90 μm. In the granulation process, the used binder to combine original powders can be a polyvinyl alcohol (PVA) or a hydroxypropyl methyl cellulose (HPMC), the predetermined amounts of the binder and the dispersant are added and dissolved into the water, and then another predetermined amount of the original powders for the protective layer is added into this water solution to form a slurry, finally the slurry is converted into a plurality of granulated powders by a spray dryer.

Further, the granulation process is divided into the following two steps: one for preparing the slurry and another for atomizing the slurry into a plurality of droplets and drying them. In the following description the granulation process for LSM powders is only used as an example, the slurries of other materials can also be used in this granulation process.

The step for preparing the slurry: Prepare 80 g submicron-sized (<1 μm) LSM powders, 200 g zirconia grinding balls and 120˜160 g deionized water. Place the prepared LSM powders, zirconia grinding balls and deionized water into a PE wild-mouth bottle and execute a ball-grinding process for 4˜6 hours at a speed of 100˜300 rpm. Then, add 12 g PVA water solution (15˜45 wt % of PVA) into the PE wild-mouth bottle and execute another ball grinding process for 30˜50 minutes at a speed of 100˜300 rpm. Further, add 2.6 g polyethylene glycol (PEG) water solution with 60˜80 wt % PEG into the PE wild-mouth bottle and execute a further ball grinding process for 30˜50 minutes at a speed of 100˜300 rpm. Then, the preparation of the LSM slurry is complete.

The step for atomizing the slurry into a plurality of droplets and drying them: A disc type atomization device is applied with a speed of 8000˜20000 rpm. A peristaltic pump having a liquid mass-transporting speed of 8˜20 g/min is used to deliver the prepared slurry into this disc type atomization device. The temperature of air for drying atomized droplets is set at 200˜300° C., and the output temperature of the cyclone collector is set at 100˜130° C. The speed of the exhaust fan can be adjusted by Variable-frequency Drive.

S2: Provide granulated powder groups and each of the granulated powder groups has a specific particle size distribution.

As described above, the granulated powders are separated into several granulated powder groups, and each of the granulated powder groups has a specific granulated powder size distribution. To achieve so and to also ensure the flow-ability thereof, the granulated powders are sieved or screened to obtain several granulated powder groups such as 5˜20 μm, 2˜45 μm, 45˜63 μm and 63˜90 μm four powder groups.

S3: Perform a pre-heating process or a pre-oxidation and pre-heating process upon a metal interconnect 10.

Whether to perform a pre-oxidation process or not is determined by the material property of the metal interconnect 10 and the effect on reducing the ASR and the increase rate of the ASR after the pre-oxidation process. To conduct the pre-oxidation process upon the metal interconnect 10, firstly the metal interconnect 10 is placed in a oven operated in the atmosphere environment and then to heat the oven to a predetermined high temperature for executing the pre-oxidation process for a predetermined time period. Preferably, the predetermined high temperature ranges from 600 to 850° C. and the predetermined time period ranges from 8 to 40 hours.

As shown in FIG. 2, the metal interconnect is 10 is placed on a planar heater 20 for a plasma spraying process. This metal interconnect can be already treated or not treated by the pre-oxidation process mentioned above. The planar heater 20 is used to pre-heat the metal interconnect is 10 to a predetermined heating temperature that ranges from 600 to 850° C. The surface temperature detection of the metal interconnect 10 can be performed by a non-contact thermometer. After the metal interconnect is pre-heated to the predetermined temperature, then, the method of the present invention can go to the coating process of performing the atmosphere plasma spraying. By the way, in the process of pre-heating the metal interconnect 10 on the planar heater 20, a heat-insulating cotton blanket can be applied on the top of the metal interconnect 10 so as to reduce possible heat loss. As the plasma spraying is ready to perform, the blanket can then be removed.

Because the metal interconnect 10 experiences a pre-heating process or a pre-oxidation and pre-heating process in the atmosphere environment, so it is inevitable that the surface of the metal interconnect 10 is oxidized during the aforesaid process.

S4: Select any one of the granulated powder groups, and send this selected granulated powder group by a powder feeder. The powder feeder delivers the granulated powders 30 of the selected granulated powder group to the powder feeding tube 31 by which the granulated powders 30 are injected into the high speed and high temperature plasma flame horizontally at a predetermined rate ranging from 1 g/min to 10 g/min.

As shown in FIG. 2, a plasma spray torch 40 is used to generate a high speed and plasma flame 400 in the atmosphere environment. The powder feeding tube 31 injects the granulated powders 30 into the high speed and high temperature plasma flame 400, in which the temperature can go up to 10,000° C. or above. The high speed and high temperature plasma flame 400 can burn out the binders in the granulated powders 30 and simultaneously heat the original powders into melted states. Also, the melted powders are accelerated to a high speed up to 650 m/s, and then impact and adhere onto the pre-heated metal interconnect 10. After a plurality of melted original powders form a continuous deposition on the preheated metal interconnector 10, a protective layer 11 is formed on the metal interconnect 10, as shown in FIG. 2. After the protective layer 11 is completely formed on the metal interconnect 10 (without post-heat treatment), the coated specimen is mounted by epoxy resin and ground to prepare a cross section for further observation by the scanning electron microscope. It is found that a middle layer is formed between the protective layer 11 and the metal interconnect 10.

The power of plasma spray torch can be adjusted in accordance with the powder sizes of the selected granulated powder group. For example, the granulated powder group having smaller powder sizes needs only a smaller power to drive the plasma spray torch, on the other hand the granulated powder group having bigger powder sizes needs a larger power to drive the plasma spray torch. The purpose of adjusting the power of plasma spray torch is to reach the melting of injected powders. The granulated powders of the selected granulated powder group prepared by a sieving or screening process provide a narrower range of the granulated powder size distribution than the granulated powders without experiencing a sieving or screening process, so that these granulated powders of the selected granulated powder group can be all melted by the plasma spray torch. On the other hand, for those granulated powders that do not experience a sieving or screening process, too small granulated powders can be overheated by the plasma flame and this overheating can cause the material change in the overheated powders. On the contrary, too large granulated powders are hard to be melted by the plasma flame and these un-melted powders can cause the voids or cracks in the protective layer.

A middle layer is generated simultaneously at the position between the metal interconnect and the protective layer, while the plasma spraying is applied to form the protective layer on the metal interconnect in the atmosphere environment. The formation of this middle layer is assisted by using the high temperature of melted powders and the pre-heating of the metal interconnect to induce the surface element migration of the metal interconnect. The other purpose of pre-heating the metal interconnect is to have the melted powders that are deposited on the surface of the metal interconnect to be integrated together so as to form a continuous and dense protective layer without the connected voids or cracks or through-cracks that penetrate the protective layer.

The details of the plasma spraying process used in an example of this invention are described below.

In the following description, the injected granulated powders 30 of the selected granulated powder group into the plasma flame 400 are the granulated LSM powders with powder sizes from 20 to 45 μm. These granulated powders are made from the original submicron-scale La_{0.8}Sr_{0.2}MnO_{3-δ} a powders by using the steps of S1 and S2. The granulated powders are delivered to the powder feeding tube 31 and then to the plasma flame horizontally, as shown in FIG. 2. The parameters of plasma spraying include: a torch power: 45 to 53 kW (current: 400 to 500 A, voltage: 100 to 110 V); a spray distance: 8 to 10 cm; a torch scanning speed: 800 to 1200 mm/sec; a powder-feeding rate: 2 to 6 g/min; a pre-heating temperature of planar heater: 600 to 850° C.; plasma gas flow rates: 49 to 55 slpm for argon, 20 to 27 slpm for helium, 2 to 5 slpm for nitrogen; and a output pressure of each gas bottle: 4 to 6 kg/cm².

As described above, the gases for forming the plasma flame are Ar, He and N₂. Because the enthalpy of plasma flame containing hydrogen gas is quite high so as to overheat the injected granulated powders, hydrogen gas is not included here. As the overheated powders impact the metal interconnect and cool down to form a protective layer on the metal interconnect, cracks are usually formed in the protective layer. In addition, the high temperature hydrogen is more active to reduce the melted powders such as LSM powders, hence some impurity phases are generated in this protective layer.

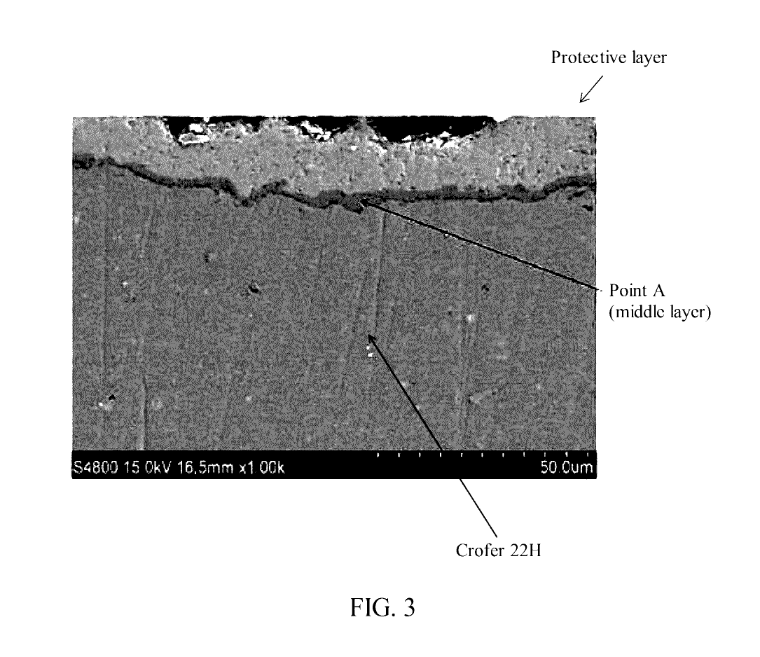

Referring now to FIG. 3, a cross-sectional SEM view of a protective layer and a middle layer prepared by the method of the present invention on a piece of pre-heated metal interconnect without any post-heat treatment in the atmosphere environment is given. In this example, the pre-heating temperature is set at 750° C., the material of protective layer is LSM (La_{0.8}Sr_{0.2}MnO_{3-δ} ) with a perovskite structure, and the material of metal interconnect is Crofer 22 H. As shown in FIG. 3, the protective layer and the middle layer are dense and continuous without the connected voids or cracks or through-cracks that penetrate the protective layer and the middle layer. Some tiny pores might exist in these layers. However, these tiny pores might be generated during the polishing process to form the specimen for SEM observation. Further, the thickness of the protective film layer typically ranges from 8 to 15 μm, but it is not limited to this range.

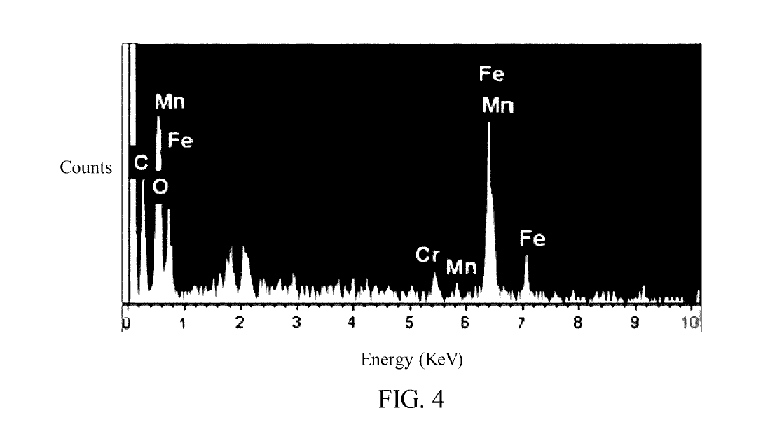

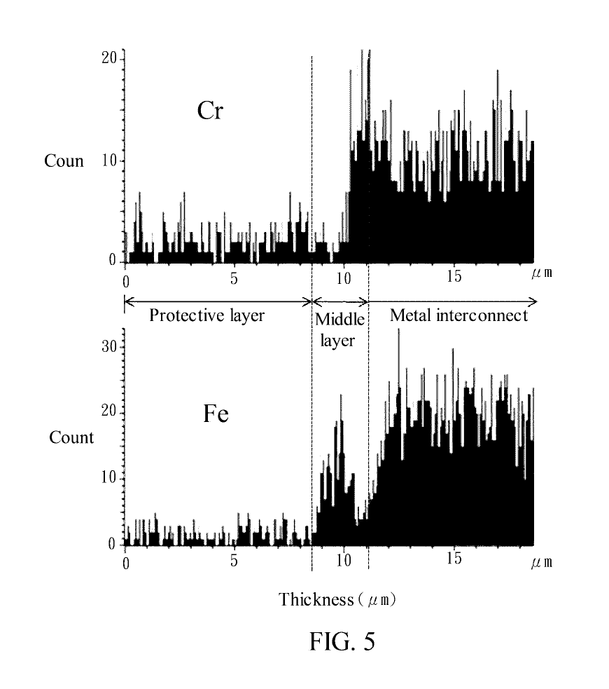

The pre-heated metal interconnect, as shown in FIG. 3, does not experience a pre-oxidation treatment. The middle layer is located between the LSM protective layer and the Crofer 22 H metal interconnect, and this middle layer is formed immediately after the LSM protective layer is completed. Referring now to FIG. 4, the signals of elements obtained from energy-dispersive X-ray spectroscopy (EDX) at the point A of FIG. 3 is shown. In this embodiment, the middle layer contains mainly Fe, Cr, O and Mn analyzed by EDX method right after forming the protective layer, as shown in FIG. 4. Specifically, the Fe is richer in the upper and middle portions of the middle layer, while Cr is richer in the lower portion (the portion that contacts or is close to the metal interconnect) of the middle layer, as shown in FIG. 5.

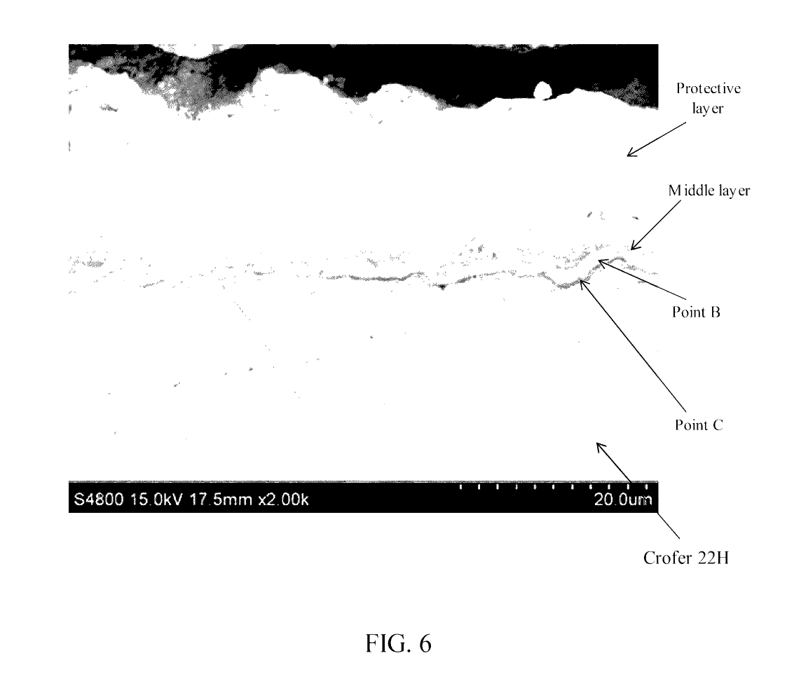

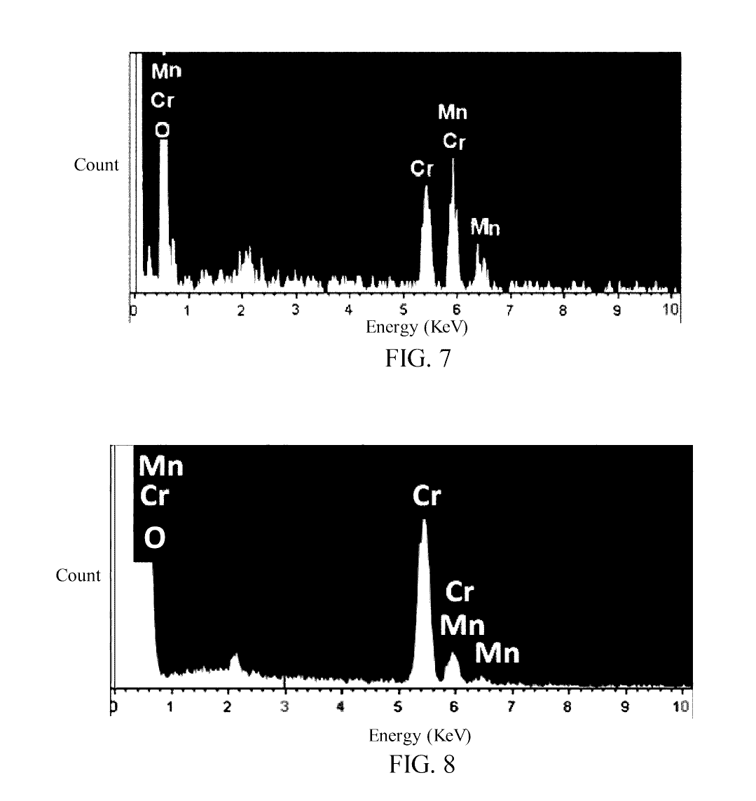

Referring now to FIG. 6, a cross-sectional SEM view of a protective layer and a middle layer prepared by the method of the present invention on a piece of pre-heated metal interconnect with a post-heat treatment at 800° C. for 600 hours in the atmosphere environment is given. The metal interconnect does not experience a pre-oxidation treatment and is pre-heated at 750° C. In FIG. 6, the LSM protective layer is dense and continuous with few tiny pores and without the connected voids or cracks or through-cracks that penetrate the protective layer. The portion of middle layer that is in contact with the metal interconnect is transformed into a continuous and dense spinel layer containing mainly Cr, Mn and O after the post-heat treatment at 800° C. for 600 hours in the atmosphere environment, according to the EDX results of FIG. 7 and FIG. 8 that show elements at the position B and C in FIG. 6 respectively. The Cr is richer at the position indicated by the point C than the position indicated by the point B. Referring further to FIG. 8, the signal of Cr is stronger than that of Mn.

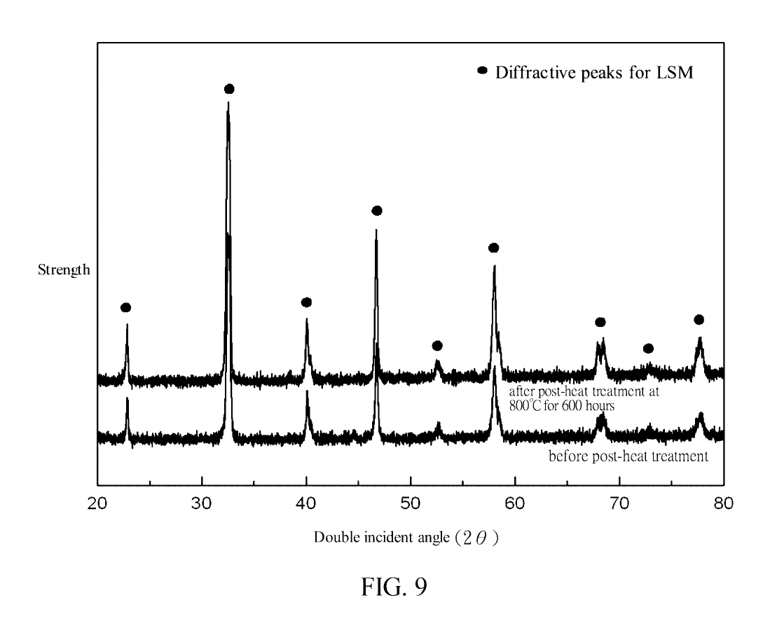

According to the Cr results shown in FIG. 5, FIG. 7 and FIG. 8, the Cr content of the middle layer decreases as the distance away from the metal interconnect increases. Namely, the protective layer and the middle layer have the function to resist the Cr to leave the metal interconnect. Referring also to FIG. 9, X-ray diffraction graphs for the protective layer before and after the post-heat treatment at 800° C. for 600 hours in the atmosphere environment are given. FIG. 9 proves that after the post-heat treatment the perovskite structure of LSM protective layer does not change and there are no significant impurity phases existing in the LSM protective layer.

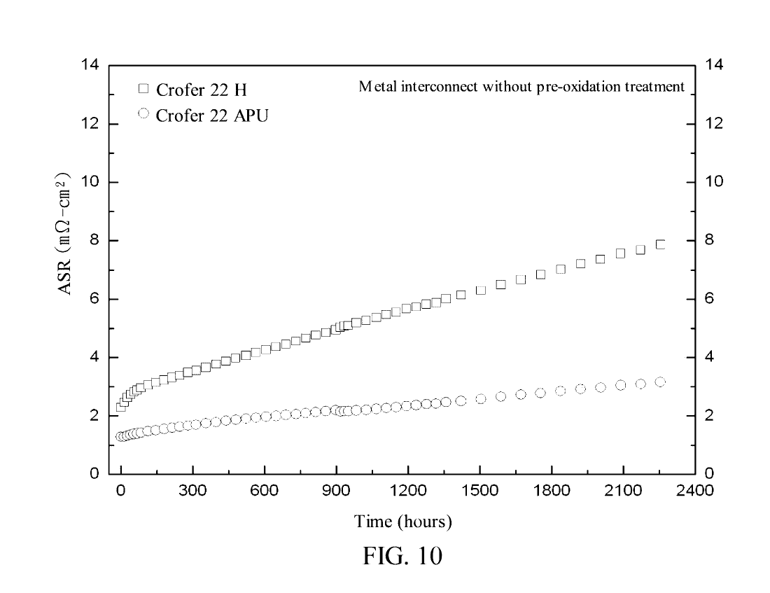

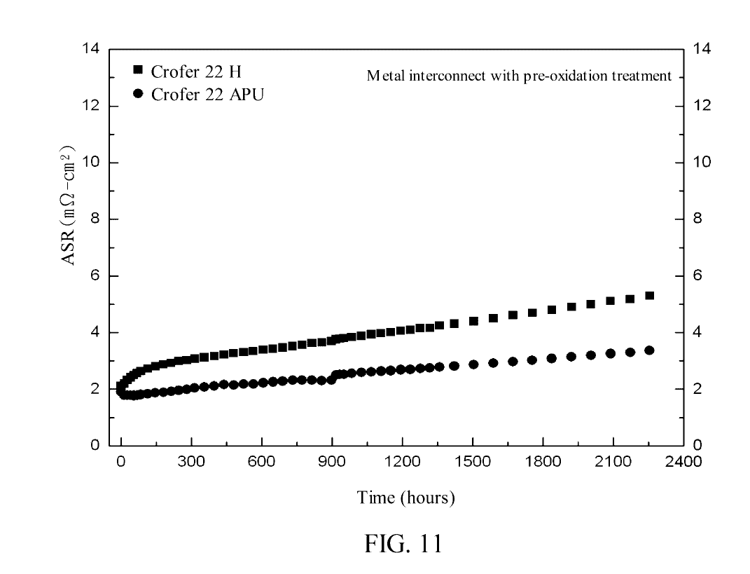

Two kinds of metal interconnects, such as Crofer 22 H and Crofer 22 APU, are used to prepared specimens by the present invention to demonstrate the effect of pre-oxidation process on the ASR measured at 800° C. in the atmosphere environment. In this example of the invention, all metal interconnects are pre-heated at 750° C. and LSM protective layers are coated on them by the atmospheric plasma spraying method. These ASR have been measured for a time period up to 2250 hours. The measured ASR results are given in FIG. 10 and FIG. 11 for these metal interconnects without and with the pre-oxidation treatment respectively. The pre-oxidation process in this example is performed at 800° C. for 12 hours. FIG. 10 show that the Crofer 22 APU metal interconnect without pre-oxidation treatment has an initial ASR about 1.25 mΩ-cm² and a final ASR about 3.2 mΩ-cm² so that the average ASR increase rate is about 0.867×10⁻³ mΩ-cm² per hour and the Crofer 22 H metal interconnect without pre-oxidation treatment has an initial ASR about 2.3 mΩ-cm² and a final ASR about 7.9 mΩ-cm² so that the average ASR increase rate is about 2.49×10⁻³ mΩ-cm² per hour. FIG. 11 show that the Crofer 22 APU metal interconnect with pre-oxidation treatment has an initial ASR about 1.75 mΩ-cm² and a final ASR about 3.4 mΩ-cm² so that the average ASR increase rate is about 0.733×10⁻³ mΩ-cm² per hour and the Crofer 22 H metal interconnect with pre-oxidation treatment has an initial ASR about 2.15 mΩ-cm² and a final ASR about 5.3 mΩ-cm² so that the average ASR increase rate is about 1.4×10⁻³ mΩ-cm² per hour. Therefore, the effects of reducing ASR and the ASR increase rate by pre-oxidation treatment are more significant on the Crofer 22 H metal interconnect than on the Crofer 22 APU metal interconnect. A SOFC generation system applying Crofer 22 H metal interconnects with pre-oxidation treatment can provide a smaller surface ohmic resistance, and thus can reduce the energy consumption of ohmic heating.

In summary, the present invention directly uses the atmospheric plasma spraying method without additional vacuum apparatus to form a protective layer and a middle layer in a continuous and dense manner over the metal interconnect simultaneously so that the connected voids or cracks or through-cracks that penetrate the protective layer and the middle layer are avoided. With such a double-layer protection and an additional pre-oxidation treatment on the metal interconnect (the material of the metal interconnect decides whether or not to use this pre-oxidation treatment), the leakage of Cr and/or Mn from the metal interconnect can be minimized. Further under this situation, the formation of a conductive, dense and continuous spinel layer containing mainly Cr, Mn and O on the metal interconnect is more favorable and the leakage of Cr and/or Mn from the metal interconnect can further be reduced, while solid oxide fuel cells work at a high temperature. By using the combined protection effect of the protective layer, the middle layer and the spinel layer, the ASR and the increase rate of the ASR can be reduced further, so that the service life of the solid oxide fuel cells as well as the generation system can be extended. Also, the Cr induced cathode poisoning can be significantly mitigated by the present invention.

While the present invention has been particularly shown and described with reference to a preferred embodiment, it will be understood by those skilled in the art that various changes in form and detail may be without departing from the spirit and scope of the present invention.

What is claimed is:

1. A growing method of layers for protecting metal interconnects of solid oxide fuel cells, comprising the steps of:
performing a pre-heating process or a pre-oxidation and pre-heating process upon a metal interconnect;
providing a plurality of granulated powder groups, selecting one of the granulated powder groups and sending the selected granulated powder group into a high speed high temperature plasma flame, wherein each of the granulated powder groups has a specific granulated powder size distribution; and
the high speed high temperature plasma flame accelerating, heating and melting the granulated powders of selected granulated powder group, the melted powders impacting a surface of the metal interconnect with a high speed so as to form a protective layer and a middle layer simultaneously on the surface of the metal interconnect,
wherein the middle layer is located between the protective layer and the metal interconnect, and the protective layer and the middle layer are dense and continuous.

2. The growing method of layers for protecting metal interconnects of solid oxide fuel cells of claim 1, wherein the pre-heating process upon the metal interconnect is to pre-heat the metal interconnect by a heater to a predetermined heating temperature.

3. The growing method of layers for protecting metal interconnects of solid oxide fuel cells of claim 2, wherein the predetermined heating temperature is set at a temperature from 600 to 850° C.

4. The growing method of layers for protecting metal interconnects of solid oxide fuel cells of claim 1, wherein the pre-oxidation process is to arrange the metal interconnect in a high-temperature air oven, then to heat the metal interconnect to a predetermined high temperature, and then to maintain the predetermined high temperature for a predetermined time period.

5. The growing method of layers for protecting metal interconnects of solid oxide fuel cells of claim 4, wherein the predetermined high temperature is set at a temperature from 600 to 850° C. and the predetermined time period is set at a time period from 8 to 40 hours.

6. The growing method of layers for protecting metal interconnects of solid oxide fuel cells of claim 1, wherein the granulated powders are produced by a granulation process, wherein the granulation process is to form the granulated powders in a shape near a ball shape by combining the original powders with a binder via a spray dryer.

7. The growing method of layers for protecting metal interconnects of solid oxide fuel cells of claim 6, wherein the granulated powders in a shape near a ball shape have diameters ranging from 10 to 90 μm and the used binder is polyvinyl alcohol (PVA) or hydroxypropyl methyl cellulose (HPMC).

8. The growing method of layers for protecting metal interconnects of solid oxide fuel cells of claim 6, wherein the original powders to be granulated for the protective layer have powder sizes of nano or submicron or micron, or powder sizes no more than 10 μm and are made of a material with poor oxygen-ion conductivity but excellent electron conductivity.

9. The growing method of layers for protecting metal interconnects of solid oxide fuel cells of claim 1, wherein the specific powder size distribution of selected granulated powder group is obtained by a sieving or screening method and the specific granulated powder size distribution is one of 5˜20 μm, 20˜45 μm, 45˜63 μm and 63˜90 μm.

10. The growing method of layers for protecting metal interconnects of solid oxide fuel cells of claim 1, wherein the granulated powders of the selected granulated powder group is injected horizontally with a powder feeding tube into the high speed high temperature plasma flame by a powder feeder at a predetermined powder-feeding rate ranging from 1 g/min to 10 g/min.

11. The growing method of layers for protecting metal interconnects of solid oxide fuel cells of claim 8, wherein the material of original powders is selected from one of LSM (La₁₋ₓSrₓMnO_{3-δ}, x=0.2˜0.4) oxides in perovskite structure or a spinel that can be Mn—Co (manganese-cobalt) spinel or Mn—Co—Fe (manganese-cobalt-iron) spinel, or Mn—Co—Cu (manganese-cobalt-copper) spinel.

12. The growing method of layers for protecting metal interconnects of solid oxide fuel cells of claim 1, wherein the protective layer does not have the connected voids or cracks or through-cracks that penetrate the protective layer.

13. The growing method of layers for protecting metal interconnects of solid oxide fuel cells of claim 1, wherein the middle layer does not have the connected voids or cracks or through-cracks that penetrate the middle layer and contains mainly Fe, Cr, O and Mn.

14. The growing method of layers for protecting metal interconnects of solid oxide fuel cells of claim 13, wherein Fe is richer in the upper and middle portions of the middle layer and Cr is richer in the lower portion of the middle layer.

15. The growing method of layers for protecting metal interconnects of solid oxide fuel cells of claim 1, wherein the protective layer and the middle layer assist the contact portion between the middle layer and the metal interconnect to transform into a dense, well-conductive and continuous spinel layer containing mainly Cr, Mn and O under the operations of the solid oxide fuel cells.

16. The growing method of layers for protecting metal interconnects of solid oxide fuel cells of claim 15, wherein the combination of the protective layer, the middle layer and the spinel layer provides a way to reduce the surface ohmic resistance of the metal interconnect and the extent of Cr induced cathode poisoning

17. The growing method of layers for protecting metal interconnects of solid oxide fuel cells of claim 1, wherein the middle layer is formed by the assistance from the high temperature of melted powders and the pre-heating of the metal interconnect so as to induce the surface element migration of the metal interconnect.

18. The growing method of layers for protecting metal interconnects of solid oxide fuel cells of claim 1, wherein the high speed high temperature plasma flame in the atmosphere environment is generated by a plasma spray torch using argon, helium and nitrogen gases.

19. The growing method of layers for protecting metal interconnects of solid oxide fuel cells of claim 1, wherein the pre-oxidation has a more significant effect on reducing ASR and ASR increase rate of Crofer 22 H metal interconnect than Crofer 22 APU metal interconnect.
